(19) United States
(12) Patent Application Publication
(10) Pub. No.: US 2005/0193265 A1
(43) Pub. Date: Sep. 1, 2005

(54) Method for installing software

(75) Inventors: Hsu-Jung Lin, Taipei (TW); Jin-Li Kuo, Taipei (TW); Hsiao-Mu Chou, Taipei (TW)

Correspondence Address: DARBY & DARBY P.C., P. O. BOX 5257, NEW YORK, NY, 10150-5257, US

(73) Assignee: SYNNEX TECHNOLOGY INTERNATIONAL CORP., Taipei (TW)

(21) Appl. No.: 10/989,257

(22) Filed: Nov. 16, 2004

(30) Foreign Application Priority Data
Feb. 25, 2004 (TW) 093104771

(51) Int. Cl. G06F 11/00

(52) U.S. Cl. 714/38

(57) ABSTRACT

In a method for installing software, distinct image files, each of which corresponds to a software bundle resident in a reference storage medium of a reference computer that was built according to a specified hardware and software configuration, stored in a master storage medium of a server that is coupled to the reference computers via a communications network are copied into copying storage media installed in copying computers. Each copying computer is configured to copy a selected image file in the copying storage medium that is installed therein into a corresponding target storage medium, which is coupled externally thereto via a connector unit. The selected image file corresponds to hardware configuration of a target computer and having a desired software configuration.

### CROSS-REFERENCE TO RELATED APPLICATION

This application claims priority of Taiwanese Application No. 093104771, filed on Feb. 25, 2004.

### BACKGROUND OF THE INVENTION

1. Field of the Invention

The invention relates to a method for installing software, more particularly to one that facilitates installation of software on a plurality of target storage media.

2. Description of the Related Art

During the manufacture of computers, aside from the need to assemble all required components, the installation of a software bundle into a hard disk is performed manually, and is thus time-consuming. Accurate software bundle installation is necessary to produce a computer having stable quality.

Usually, software bundle installation into a larger number of hard disks is performed to cope with production requirements. However, when the software bundles stored in the hard disks are required to be revised for computers having different hardware configurations, reprocessing of the hard disks is necessary, which results in longer production time.

Pre-installation of operating system, hardware driver software and application software before delivery has become a requirement of most consumers. Since computers are manufactured in batches, typically in unit of thousands, it will not be cost-effective to manually install software on each computer. Therefore, computer manufacturers nowadays apply an image file installation technique during the process of installing software bundles on large numbers of computers.

In the conventional method, a reference storage space (or the whole hard disk or other types of storage media) having a software bundle resident therein is first coded into an image file. Then, the image file is decoded for storage in the target storage space of each of a plurality of target computers having identical hardware configurations in a production line. Since the target storage spaces have the same contents, the target computers are thus installed with the same software bundle.

A drawback of the conventional method resides in that only one image file is used at a time. The conventional method is thus suitable for the mass production of computers with only one set of hardware and software configurations, and cannot be applied when computers with more than one set of hardware and software configurations are to be produced at the same time. Furthermore, the conventional method requires downloading of the image file from a reference storage medium to each target computer for subsequent decoding. The downloading task is time-consuming.

### SUMMARY OF THE INVENTION

Therefore, the object of the present invention is to provide a method for installing software that can overcome the aforesaid drawbacks associated with the conventional software installation method.

According to the present invention, there is provided a method for installing software. The method comprises the steps of:
a) creating a set of distinct image files, each of which corresponds to a software bundle resident in a reference storage medium of a reference computer that was built according to a specified hardware and software configuration;
b) storing the image files created in step a) in a master storage medium of a server that is coupled to the reference computers via a communications network;
c) providing a plurality of copying computers, each of which is coupled to the server via a router;
d) copying the image files stored in the master storage medium into a copying storage medium installed in each of the copying computers;
e) providing a plurality of target storage media externally of the copying computers and the server, each of the copying computers being coupled to a corresponding one of the target storage media via a respective connector unit; and
f) enabling each of the copying computers to copy a selected one of the image files in the copying storage medium that is installed therein into the corresponding one of the target storage media, the selected one of the image files corresponding to hardware configuration of a target computer and having a desired software configuration.

### BRIEF DESCRIPTION OF THE DRAWINGS

Other features and advantages of the present invention will become apparent in the following detailed description of the preferred embodiment with reference to the accompanying drawings, of which:

FIG. 1 is a flowchart illustrating the preferred embodiment of a method for installing software according to this invention;

FIG. 2 is a schematic diagram illustrating physical components for performing the method of the preferred embodiment;

FIG. 3 is a flowchart illustrating an image file creation procedure of the method of the preferred embodiment; and

FIG. 4 is a perspective view showing a mounting seat mounted with a target storage medium according to the method of the preferred embodiment.

### DETAILED DESCRIPTION OF THE PREFERRED EMBODIMENT

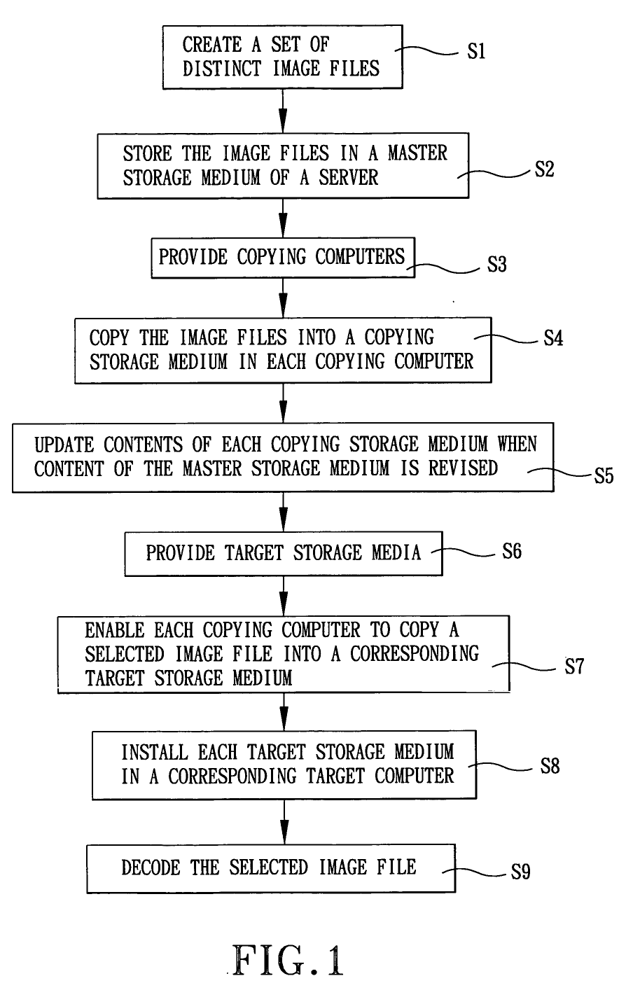

Referring to FIG. 1, the preferred embodiment of a method for installing software according to the present invention is shown.

Prior to performing the method of the preferred embodiment, the computer manufactures first defines hardware and software configurations for all computers scheduled for production. A software configuration includes at least one of an operating system, hardware driver software and application software that form a specified software bundle. A code is assigned to every software via a coding rule based on the types of the operating system, the hardware driver software and the application software that are available. In this embodiment, the coding rule for the hardware driver software is as follows: For more important hardware components, such as motherboards, video cards, TV cards, etc., since there are many part providers and model numbers available, two alphanumeric characters are used for coding. For less important hardware components, such as modem cards, network cards, etc., since the computer manufacturer normally has only a limited variety of models by different part providers on stock, a single alphanumeric character is sufficient for coding. As for the application software, a single alphanumeric character is also sufficient for coding. The codes assigned to the selected operating system, hardware driver software and application software are combined to form a serial code corresponding to a desired software configuration. The serial code is then formed into a machine-readable code, such as a bar code. For instance, if a reference computer of a specific model provided by the computer manufacturer is equipped with a motherboard of model number XX1, a video card of model number XX2, a modem card of model number XX3, a TV card of model number XX4, Windows XP home version and Office XP, of which the assigned codes are 09, 1D, 1, 1, 4 and 7, and if the reference computer is not equipped with a network card, the assigned code being a default value of 0, the complete serial code will be 091D10147. In practice, the length and content of the serial code can vary according to actual requirements.

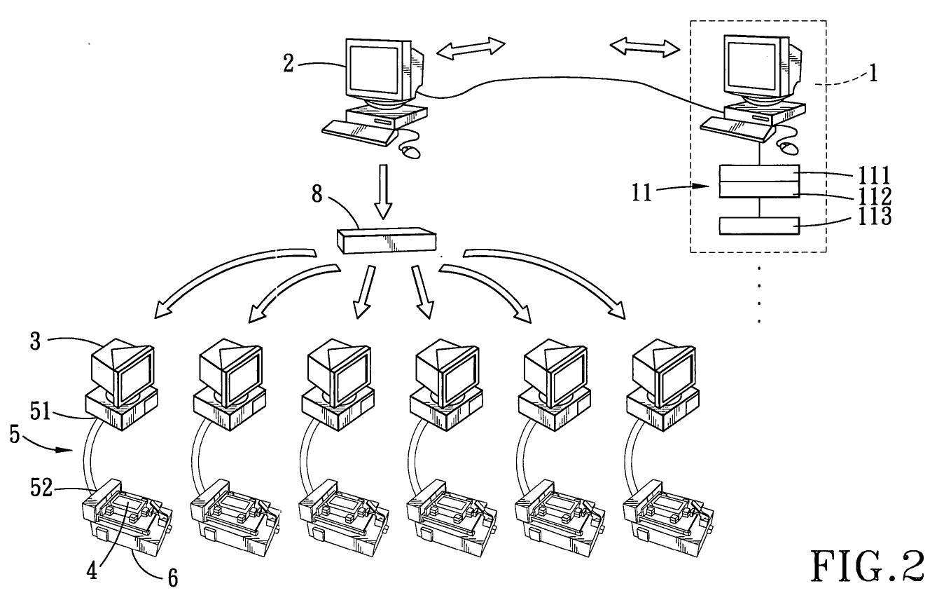

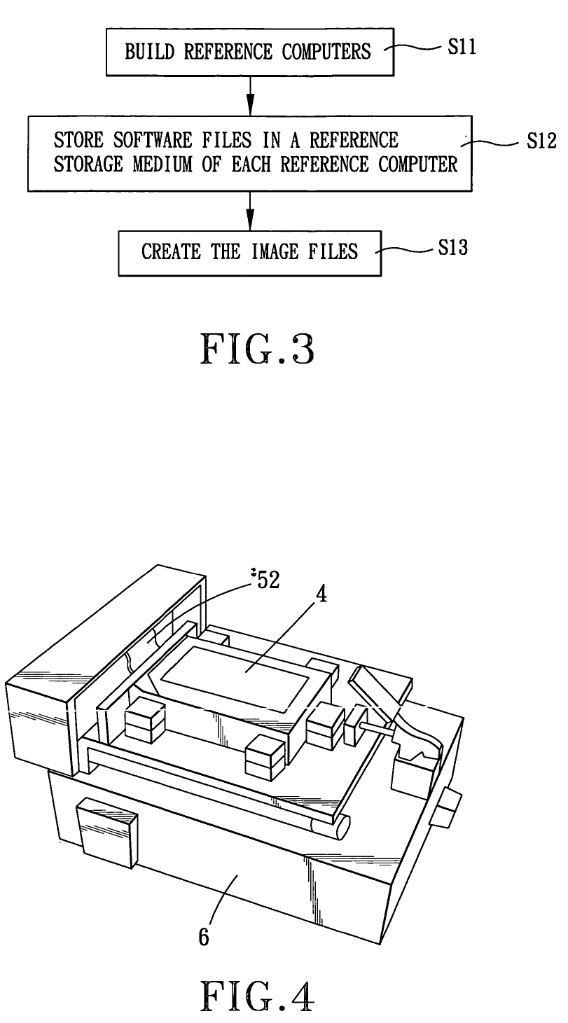

As shown in FIGS. 1 to 3, a set of distinct image files 113 is created in Step S1. Each of the image files corresponds to a software bundle resident in a reference storage medium of a reference computer 1 that was built according to a specified hardware and software configuration. In this embodiment, during the image file creation procedure (step S1), a plurality of the reference computers 1 (only one is shown in FIG. 2) are built to have the specified hardware configurations corresponding to the serial codes (step S11 in FIG. 3). The reference storage medium 11 of each of the reference computers 1 is a hard disk in this embodiment. For instance, the reference computer 1 built according to the aforesaid serial code 091D10147 will have a motherboard of model number XX1, a video card of model number XX2, a modem card of model number XX3 and a TV card model number XX4, and no network card. In this embodiment, the reference storage medium 11 of each reference computer 1 is divided into first and second storage spaces 111, 112 (see FIG. 2). Software files, i.e., source files of the operating system corresponding to the serial code, are copied to the second storage space 112 of the reference storage medium 11. Thereafter, the source files of the operating system in the second storage space 112 are used to install the operating system in the first storage space 111. Then, all hardware driver software and application software corresponding the serial code are installed in the first storage space 111. The software bundle corresponding to the serial code is stored in the first storage space at this time (step S112 in FIG. 3). Therefore, the software bundle stored in the first storage space 111 for the aforesaid serial code 091D10147 will be the Windows XP home version operating system, the Office XP application software, and the hardware driver software for a motherboard of model number XX1, a video card of model number XX2, a modem card of model number XX3 and a TV card model number XX4. Finally, the contents of the first storage space 111 of the reference storage medium 11 of each reference computer 1 are coded and compressed to form a corresponding image file. In this embodiment, the software GHOST is used for coding and decoding the image file, and the image compression option in the software GHOST is selected to reduce the file size upon coding. The set of distinct image files 113 corresponding to the specified hardware and software configurations is thus created at this time (step S113 in FIG. 3). It is noted that each of the image files 113 preferably has a filename identical to the corresponding serial code. For instance, the filename of the aforesaid image file 113 is 091D1014.7 in a DOS filename format.

A server 2 is coupled to the reference computers 11 via a communications network, and has a master storage medium (not shown). The image files 113 created in step S1 are stored in the master storage medium of the server 2 (step S2).

A plurality of copying computers 3 are provided in step S3. Each of the copying computers 3 is coupled to the server 2 via a router 8 (see FIG. 2), and is installed with a copying storage medium (not shown). In this embodiment, the master storage medium and the copying storage media of the copying computers 3 are identical in construction.

In Step S4, the image files stored in the master storage medium are copied into the copying storage medium of each copying computer 3.

It is noted that the content of each copying storage media is updated when the content of the master storage medium is revised to maintain consistency between the master storage medium and the copying storage media in step S5.

A plurality of target storage media 4 are provided externally of the copying computers 3 and the server 2 (step S6). Each of the target storage media 4 is mounted detachably on a mounting seat 6 in this embodiment, as best shown in FIG. 4. As shown in FIGS. 2 and 4, each of the copying computers 3 is coupled to a corresponding one of the target storage media 4 via a respective connector unit 5. In this embodiment, the connector unit 5 includes a hot-plug interface 51 coupled to the corresponding one of the copying computers 3, and a converting interface 52 provided on the mounting seat 6 and coupled to the corresponding one of the target storage media 4 when the latter is mounted on the mounting seat 6. For instance, the target storage media 4 are hard disks available for IDE data transmission. Therefore, when the hot-plug interface 51 is an IEEE 1394 interface, the converting interface 52 can be an IEEE 1394/IDE converting interface. Alternatively, when the hot-plug interface 51 is a USB interface, the converting interface 52 can be a USB/IDE converting interface.

Each of the copying computers 3 is configured to copy a selected one of the image files in the copying storage medium that is installed therein into the corresponding one of the target storage media 4 (step S7). The selected one of the image files corresponds to hardware configuration of a target computer (not shown), and has a desired software configuration. In practice, each of the copying computers 3 is disposed on a corresponding production line, and is accompanied with a run card on which a machine-readable code in the form of a serial code, i.e., a bar code, described beforehand and corresponding to the selected one of the image files is listed. As such, by reading the machine-readable code listed on the run card, selection of one of the image files can be carried out. Each of the target computers is provided with a serial code corresponding to the selected one of the image files.

In step S8, each of the target storage media 4 is installed in a corresponding target computer. Finally, for each of the target computers, the selected one of the image files is decoded to result in the software bundle that is stored in the target storage medium 4 which is installed in the target computer (step S9).

The following are some of the advantages of the method of the present invention:
1. This invention permits the simultaneous manufacture of computers having different hardware and software configurations in a single production line.
2. Because only the selected image file is copied from a copying storage medium to the target storage mediim 4, instead of installing software bundles piece-by-piece or downloading several image files via reference computers for software bundle installation, production time and costs can be reduced.
3. Due to the presence of the hot-plug connecting unit 5, replacement of a target storage medium to be processed is permitted while the corresponding copying computer 3 is in an on-state such that production time and costs can be reduced.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A method for installing software, comprising the steps of:
a) creating a set of distinct image files, each of which corresponds to a software bundle resident in a reference storage medium of a reference computer that was built according to a specified hardware and software configuration;
b) storing the image files created in step a) in a master storage medium of a server that is coupled to the reference computers via a communications network;
c) providing a plurality of copying computers, each of which is coupled to the server via a router;
d) copying the image files stored in the master storage medium into a copying storage medium installed in each of the copying computers;
e) providing a plurality of target storage media externally of the copying computers and the server, each of the copying computers being coupled to a corresponding one of the target storage media via a respective connector unit; and
f) enabling each of the copying computers to copy a selected one of the image files in the copying storage medium that is installed therein into the corresponding one of the target storage media, the selected one of the image files corresponding to hardware configuration of a target computer and having a desired software configuration.

2. The method as claimed in claim 1, further comprising the steps of:
g) installing each of the target storage media in a corresponding target computer; and
h) for each of the target computers, decoding the selected one of the image files to result in the software bundle that is stored in the target storage medium which is installed in the target computer.

3. The method as claimed in claim 1, where in said step
a) includes the sub-steps of:
a-1) building a plurality of the reference computers such that each of the reference computers has the specified hardware configuration;
a-2) storing software files in the reference storage medium of each of the reference computers to result in the software bundle and to configure each of the reference computers with the specified software configuration; and
a-3) creating the image files that correspond respectively to the software bundles in the reference storage media of the reference computers.

4. The method as claimed in claim 1, wherein the master storage medium and the copying storage media are identical in construction.

5. The method as claimed in claim 1, further comprising the step of updating content of each of the copying storage media when content of the master storage medium is revised to maintain consistency between the master storage medium and the copying storage media.

6. The method as claimed in claim 2, wherein, in said step f), each of the target computers is provided with a serial code corresponding to the selected one of the image files.

7. The method as claimed in claim 6, wherein the serial code is a machine-readable code.

8. The method as claimed in claim 7, wherein the machine-readable code is a bar code.

9. The method as claimed in claim 7, wherein, in said step f), selection of one of the image files is carried out by reading the machine-readable code.

10. The method as claimed in claim 9, wherein the selected one of the image files has a filename corresponding to the machine-readable code of the target computer.

11. The method as claimed in claim 10, wherein the machine-readable code includes at least one of a first code portion corresponding to a desired operating system, a second code portion corresponding to a desired hardware driver software, and a third code portion corresponding to a desired application software.

12. The method as claimed in claim 1, wherein the software bundle includes at least one of an operating system, hardware driver software, and application software.

13. The method as claimed in claim 1, wherein the connector unit includes:
a hot-plug interface coupled to the corresponding one of the copying computers; and
a converting interface coupled to the corresponding one of the target storage media.

14. The method as claimed in claim 13, wherein the hot-plug interface includes an IEEE 1394 interface.

15. The method as claimed in claim 14, wherein each of the target storage media is a hard disk, the converting interface being an IEEE 1394/IDE converting interface.

16. The method as claimed in claim 13, wherein the hot-plug interface includes a USB interface.

17. The method as claimed in claim 16, wherein each of the target storage media is a hard disk, the converting interface being a USB/IDE converting interface.
